(19) United States
(12) Patent Application Publication
(10) Pub. No.: US 2005/0159220 A1
(43) Pub. Date: Jul. 21, 2005

(54) METHOD AND INTERFACE SYSTEM FOR FACILITATING ACCESS TO FANTASY SPORTS LEAGUES

(76) Inventors: GORDON WILSON, Calgary (CA); TODD G. SIMPSON, Calgary (CA)

Correspondence Address: BENNETT JONES;C/O MS ROSEANN CALDWELL, 4500 BANKERS HALL EAST, 855 - 2ND STREET, SW, CALGARY, AB, T2P 4K7, CA

(21) Appl. No.: 10/905,106

(22) Filed: Dec. 15, 2004

(30) Foreign Application Priority Data
Dec. 15, 2003 (US) 60/529,266

(51) Int. Cl. G06F 19/00; G06F 17/00

(52) U.S. Cl. 463/40

(57) ABSTRACT

A multi-modal interface for facilitating access to an interactive sports contest using a telephony-based device, comprising an interactive voice recognition system and a central processing unit which can provide access to a database of contestants and a database of players of interest, wherein a contestant in the interactive sports contest can register, select a virtual team of players and manage the team through the multi-modal interface. Due to the ubiquitous nature of telephony-based devices, contestants can interact with interactive sports contests such as fantasy sports leagues in a timely, user-friendly and possibly personalized fashion. The multi-modal interface can be configured to accept voice-only commands from contestants, as well as provide contestants with notifications of statistics or events at a predetermined time and frequency. The notification can also be sent using a telephony-based device-specific format.

### FIELD OF THE INVENTION

The present invention relates to the field of interactive interface systems for facilitating access to fantasy sports leagues through voice-based and multi-modal means of communication.

### BACKGROUND

Interactive contest systems are rapidly growing in popularity, membership and usage throughout the world. These types of interactive contests are quite varied in form and include Fantasy Sports Leagues (FSLs). In FSLs, contestants assume the role of a general manager of an imaginary professional sports team and select players of interest from a roster to form their virtual team. FSLs can cover a wide range of different sports, ranging from major sports like basketball, baseball, soccer, golf, football, cricket and hockey, through to car racing, horse racing, or even darts or bowling. The contest may be based on the ability of contestants to form the virtual team that gain points based upon the outcomes and statistics of live sporting events. The rules governing the calculation of contestant standings can range from very simple to complex, depending on the FSL. Typically, the contestant having picked the best virtual team will be awarded a prize. Prizes can range from large items awarded only at the end of the season, to specific event-based prizes, to weekly or monthly prizes, to the largest points gain in a given timeframe, and many other variations. Moreover, some FSLs will also provide other prizes to motivate contestants to participate.

The overall organization of FSLs can vary widely, and include purely static games to fully dynamic games. In a static game, such as a newspaper- or magazine-based system, the contestants will make their selections at the beginning of a season or event, and simply watch their status relative to other players. However, in a dynamic game, which is often an Internet-based system, the contestants will make their initial selections, but then be allowed to make changes, for example, to players, virtual teams, or point spreads, throughout the playing season based on various factors and statistics such as injuries, performance, etc.

FSLs can be supported using a variety of different measures, and include contestant-supported FSLs, socially driven FSLs (i.e., office pools) and marketing-driven FSLs. Contestant-supported FSLs charge each contestant registration and transaction fees. Marketing-driven FSLs do not charge any fees to the contestants, but rather generate revenue from advertising, awareness, or increased usage of a secondary revenue-generating product, such as a television channel or a publication like a newspaper. However, these different types of FSLs often overlap.

To date, the major interfaces to FSLs have been through printed publications such as newspapers or magazines, and through the Internet. In FSLs using an interface based on a printed publication, contestants must register by filling out a form contained in the publication. For example, if the publication is a newspaper, a physical page of the newspaper will allow users to register their virtual team selections by filling in blanks, and then mailing the completed form to the FSL provider. The newspaper will then publish, on a regular basis, the top ranking contestants in the FSL, as well as, in certain instances, statistics on the players of interest and teams. In FSLs using an Internet-based interface, contestants can directly access web forms and provide the same information as that provided in publication-based FSLs, as described above. The use of an Internet-based interface allows for the more timely delivery of various statistics, as well as greatly simplifies the modification of virtual team member selections by contestants. Many of the FSLs that have more interactive interfaces are now promoted through affiliated television or radio programs; in some instances, a daily or weekly program is devoted to the FSL, which attests to the growing popularity of this type of interactive contests.

However, Internet-based interfaces as well as interfaces based on a printed publication have many challenges. Interfaces based on a printed publication are expensive to maintain because of data entry and publication fees. Also, in such types of interfaces, a contestant must have constant access to the printed publication to participate in the FSL, since, in most cases, the printed publication will be the only source of information regarding statistics and standings. Internet-based interfaces are much richer, but require easy access to the Internet. While access to the Internet is widely available in parts of Europe and North America, it is not as widely available in the rest of the world. Moreover, in North America, the Internet is most widely used at corporate locations, where interacting with FSLs on a timely basis is often discouraged. In addition to the problem of accessibility, both types of interfaces do not readily allow for modifications to be made in almost real-time, for example modifications made for a daily match.

Consequently, the need has arisen for a more generic, more widely accessible interface to FSLs that can allow contestants to easily access FSLs to register and manage their virtual teams on a daily basis at any time.

### SUMMARY

In accordance with a broad aspect of the present invention, there is provided a multi-modal interface for facilitating access to an interactive sports contest using a telephony-based device, comprising: an interactive voice recognition system and a central processing unit, which provides access to a database of contestants and a database of players of interest, wherein a contestant in the interactive sports contest can register, select a virtual team of players of interest and manage the team through the multi-modal interface.

In one embodiment, the contestant can query the databases using voice-only commands. In one embodiment, the contestant can make transactions using voice-only commands. In one embodiment, the interactive voice recognition system comprises a voice recognition engine and a text-to-speech engine. In one embodiment, the multi-modal interface further comprises a billing system. In one embodiment, the multi-modal interface facilitates access to the interactive sports contest using a location-based system.

In accordance with another broad aspect of the present invention, there is provided a method for facilitating access for contestants to an interactive sports contest, which method comprises the steps of: providing a multi-modal interface comprising an interactive voice response system to which the contestants can connect using telephony-based devices; using the interactive voice response system, recording voice-only commands from the contestants for registration, team selection and management transactions; storing recorded information in a database of registered contestants; and responding to the voice-only queries of contestants and sending requested information in a format optimized for the telephony-based devices of the contestants.

In one embodiment, the requested information is sent by voice. In one embodiment, the requested information is sent by voice message. In one embodiment, the requested information is sent by voice message. In one embodiment, the method further comprises charging a fee for each transaction and query made by the contestants.

In accordance with another broad aspect of the present invention, there is provided a system for sending a notification of data or events to a contestant in an interactive sports contest through a telephony-based device, comprising: a database of contestants registered with the interactive sports contest; a database of data on players of interest; an interactive voice recognition system; and a central processing unit.

In one embodiment, the contestants can configure which data and events will trigger sending the notification. In one embodiment, the database of contestants contains instructions by the contestants on the type and frequency of the requested notification. In one embodiment, the notification is sent daily. In one embodiment, the notification is sent by voice. In one embodiment, the notification is sent by voice message. In one embodiment, the notification is sent by a messaging interface. In one embodiment, the notification is sent through a web interface. In one embodiment, the notification is sent in almost real time.

### BRIEF DESCRIPTION OF THE DRAWINGS

FIG. 1 is a high level view of one embodiment of the multi-modal interface to FSLs of this invention.

FIG. 2 is a diagrammatic illustration showing an exemplary embodiment of a flow chart of a contestant trading a player of interest for another using the multi-modal interface of this invention.

### DESCRIPTION

An interface, as described herein, provides contestants with an interactive and dynamic access to a FSL, through which they can register, select a virtual team of players of interest, manage their virtual team, trade players, and obtain statistics in a timely, user-friendly and possibly personalized fashion. The interface can allow contestants to access a particular FSL using a variety of different telephony-based devices. The interface can be multi-modal because several different formats of communication can be used together to facilitate and encourage use. Once contestants have registered with a FSL through the interface, they can select a virtual team of players of interest and manage their virtual team(s) at any time on a daily basis due to the ubiquitous nature of telephony-based devices. Using the interface, contestants can connect to and query the FSL for specific statistics regarding a certain team and/or a certain player without resorting to a specific printed publication or website. Moreover, the interface may also provide more personalized information through the ability to request that statistics from the FSL regarding any or all players on a team, team standings and/or contestant standings be sent to a contestant's telephony-based device at a pre-determined time every day, once a week, etc.

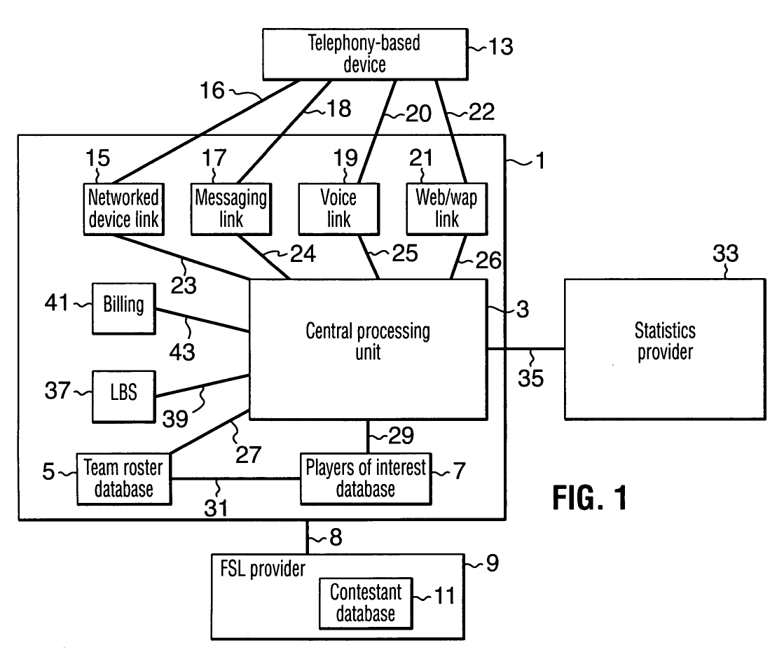

FIG. 1 shows a possible embodiment of a multi-modal interface 1 of the present invention, which comprises at least a central processing unit 3, a team roster database 5, and a players of interest database 7. The interface can be connected through a connector 8 to a FSL provider 9. FSL provider 9 or multi-modal interface 1 can include a contestant database 11. In this diagram, a contestant using a single telephony-based device 13 is shown interacting with the interface. However, it is to be understood that a plurality of telephony-based devices can interact with the interface at the same time.

Multi-modal interface 1 can act as a gateway between a contestant and a FSL, where contestants registered in FSL provider 9 can communicate with the FSL and/or with each other to select and trade players of interest to manage their virtual teams, as well as to obtain statistical information instantly and in real-time. In multi-modal interface 1, different formats of communication can be used together to facilitate and encourage the use of a FSL as well as to increase its membership. To communicate with a FSL through multi-modal interface 1, a contestant can use telephony-based device 13, which can take various forms, and can include, for example, which are not meant to be limiting, devices such as landline telephones, cellular phones, smart phones, personal data assistants (PDAs), personal computers, Voice-over-IP devices, wireless application protocol-based (wap) devices, etc. Of course, one skilled in the art will understand that many different communication devices are available and continue to evolve rapidly, and although the details of different communication devices may vary greatly, each can be used to connect with FSL provider 9 using multi-modal interface 1. Moreover, additional links can be added so that the use of Instant Messaging and Presence Services (IMPS) can be supported by multi-modal interface 1. The use of IMPS can support interaction between contestants as opposed to interaction solely between a contestant and the FSL. This type of interaction can be particularly advantageous in FSLs where a player of interest can only be part of one contestant's virtual team, and removing or adding players of interest between virtual teams or on fantasy team databases is performed throughout the season.

The use of various telephony-based devices to connect with FSL provider 9 through multi-modal interface 1 can be accomplished through the presence of a number of communication device links. As is apparent, the types of links that can be used will vary with the type of communication device used with the interface. In one embodiment, as shown in FIG. 1, a networked device link 15 can be used for devices, which include, but are not limited to, internet protocol telephones, and can be accessed through a connector 16. A messaging-based device link 17 can be used for existing and evolving messaging interfaces such as Short Messaging Service (SMS), Extended Short Messaging Service (EMS), Multimedia Messaging Service (MMS), Instant Messaging, and the future evolution of these, and can be accessed through a connector 18. A voice-based device link 19 can be used for voice access to the interface, which can support both landline and cellular access as well as Voice-over-IP based devices, and the like, and can be accessed through a connector 20. A web/wap based device link 21 can be used for Internet content for telephony-based devices capable of sending and receiving data under wap format, or any variant of HTML, such as XHTML, as well as over-the-air (OTA) based delivery (i.e., Java-based components), and can be accessed through connector 22. Connectors 16, 18, 20 and 22 can take various forms, which can include, but are not limited to, a telephone line, or other physical or non-physical components. Non-physical components can be used to enable the use of wireless technologies. Of course, additional links and connectors can be added to facilitate communication with other types of communication devices.

Networked-based device link 15, messaging-based device link 17, voice-based device link 19, and web/wap-based device link 21 can include a number of different components, depending, as one of skill in the art will understand, on the particular requirements of a specific telephony-based device. These components can include, but are not limited to, an interactive voice response (IVR) system, which can include various engines such as a text-to-speech (TTS) engine, a messaging engine, a browsing engine, as well as an engine for OTA-based delivery. In one embodiment, the various different engines can be interfaced through the use of an interaction protocol such as, for example, which is not meant to be limiting, VoiceXML.

VoiceXML can be of particular usefulness in voice-based device link 19. In the case of voice-based device link 19, an IVR system, which can function in combination with central processing unit 3, can convert a voice excerpt into a written, text segment of a specific human language, such as English. As is apparent, any human language could be used by an IVR system. This conversion can be particularly useful for communicating with a FSL provider, which may only be able to respond to text commands. In this case, any voice commands received from a contestant through voice-based device link 19 in multi-modal interface 1 would first be converted to text, and then sent to the FSL provider. To provide contestants with a voice-based response, a TTS engine can be used to convert any text communication received from the FSL provider to voice, which can then be relayed to the contestant. A TTS engine can take a written text segment of a human language and convert it to an audio excerpt. It should be noted that, although dialogs through multi-modal interface 1 can be structured to allow for free form input, directed dialogs can be used when required, for example if a contestant has a heavy accent or a simpler system is desired.

In another embodiment, dual tone multi-frequency-based (DTMF) interaction can also be supported, where a contestant can use a keypad on their telephony-based device to communicate with a FSL through multi-modal interface 1. As an example, a contestant may be prompted to “Say or touch 1 for response X”.

The various communication links provided in multi-modal interface 1 can function to permit communication between a contestant's telephony-based device and central processing unit 3 of the interface. These communication links can be connected to the central processing unit through connectors 23, 24, 25 and 26. One of skill in the art will understand that these connectors can take various forms and are not limited to any particular type of physical component, non-physical component or wireless, cellular, radio, and/or satellite technology. Central processing unit 3 in multi-modal interface 1 can function to receive data from and to transmit data to contestants regarding their selected virtual team, thereby permitting contestants to select and manage their virtual teams from their telephony-based device. The communication links can serve to translate any information incoming from a telephony-based device through connectors 16, 18, 20 or 22 into a form easily understood by central processing unit 3. They also serve to translate any information sent by central processing unit 3 into a form recognized by the particular telephony-based device used by a contestant.

To facilitate, enrich and encourage the use of multi-modal interface 1, the central processing unit can also have the ability to recognize the requirements and limitations of the telephony-based device used by the contestants. This can allow for a more personalized and richer interaction with multi-modal interface 1, whereby any information sent by the interface can be customized to better suit the telephony-based device used by the contestant. For example, which is not meant to be limiting, if a contestant is using a telephony-based device with messaging or Internet-browsing capabilities, certain information can be sent in text form as well as in voice form. However, for contestants using telephony-based devices that are not enabled with these features, the information would only be sent in voice format.

The central processing unit can have access to team roster database 5 and players of interest database 7. The location of team roster database 5 and players of interest database 7 can vary. In FIG. 1, team roster database 5 and players of interest database 7 are shown as being outside of central processing unit 3, but within multi-modal interface 1. However, in another embodiment (not shown), team roster database 5 and players of interest database 7 can be included within central processing unit 3. In another embodiment (not shown), these databases can be located within FSL provider 9. Access to team roster database 5 and players of interest database 7 by the central processing unit can be established in a plurality of different ways, which can include, but are not limited to, accessing these databases through various connectors. One of skill in the art will understand that the nature of these connectors will vary depending on the location of the databases. In FIG. 1, connectors 27 and 29 connect team roster database 5 and players of interest database 7 to central processing unit 3, respectively. In one embodiment as illustrated in FIG. 1, a connector 31 can also connect team roster database 5 to players of interest database 7. Again, connectors 27, 29, and 31 can be various physical or non-physical technologies or programming.

Team roster database 5 can contain information about contestants and their selected virtual teams of players of interest. Players of interest database 7 can contain data relating to players of interest available for selection in the FSL and possibly information regarding each player. The information contained within team roster database 5 and players of interest database 7 can include, but is not limited to, miscellaneous data, statistics, rankings, etc. The data contained within team roster database 5 and players of interest database 7 can be updated through the use of a statistics provider 33 at various intervals, which can include, but are not limited to, hourly, daily, weekly, etc. Statistics provider 33 can take various forms, and can include, but is not limited to, individuals, unassociated inputers, the FSL provider, a sports organization that collects statistics on players of interest and teams, etc. In the embodiment shown in FIG. 1, statistics provider 33 can be connected to central processing unit 3 through a connector 35. Through connector 35, central processing unit 3 can receive statistics on sports teams of interest and players of interest, and thereby can update team roster database 5 and players of interest database 7 through connectors 27 and 29, respectively. In another embodiment (not shown), statistics provider 33 can be directly connected to team roster database 5 and players of interest database 7.

A contestant can thus, using a telephony-based device, connect to multi-modal interface 1 in order to access a FSL and manage their virtual teams. Most FSLs require each contestant to first register in order to participate. Registration can be performed through multi-modal interface 1, in one embodiment, by the contestants dialing a known telephone number that will connect them with the interface. Of course, contestants can connect with the interface in a plurality of different ways, which can include ways in which dialing a specific phone number is not required. In one embodiment, a contestant may register using a logic identifier and password, which are unique to the contestant. The logic identifier and password may be entered in multi-modal interface 1 through a communication link using an IVR system, or entered using DTMF commands. If entered using the IVR system, the logic identifier and password can be verified using a voice identification system. In another embodiment, a contestant may register using voice verification systems, which may be included within an IVR system. Typically, several representative utterances from the contestant will be recorded, and then used to verify the identity of the person in future calls. Moreover, voice verification systems often randomize the verification utterances so that recordings of the contestant's voice cannot be used to wrongfully access the FSL. For example, the representative sample utterances obtained from the contestant may be the numbers from one to nine. The verification sequence could then be a random five-digit number, which the contestant must say in order to gain access to the FSL.

During registration, a contestant may configure various personal settings with the FSL in order to personalize and enrich interactions with the FSL through multi-modal interface 1. These settings include, but are not limited to, selecting interest groups, setting permissions to receive marketing material, and requesting notification of certain events. These settings can be stored in contestant database 11, which can be located in FSL provider 9 as shown in FIG. 1, or incorporated into multi-modal interface 1.

In one embodiment, registration may be limited to contestants who reside in a specific geographical region or area. Some FSLs may be configured to function only in certain areas. In another embodiment, some statistical updates may only be relevant to contestants in specific regions. To enable the application of geographical restrictions, multi-modal interface 1 can include a location-based system (LBS) 37. LBS 37 may obtain location information from the cellular system based on cellular phone identification, cell site usage, cell site triangulation, a global positioning system (GPS), an assisted GPS (AGPS) that uses a combination of cell sites and GPS to establish location, or hybrid data such as E911 specifications. Moreover, location information may be obtained from landline telephones through the use of reverse white pages lookups. In one embodiment, location information may also be provided by the contestant during registration. In any of the above-described embodiments, location information may be stored within contestant database 11. As shown in FIG. 1, LBS 37 can be accessed by central processing unit 3 through connector 39, which is not limited to any particular form or technology.

Depending on the FSL provider with which multi-modal interface 1 is used, a contestant may have to provide billing information upon registration and this information may be stored in contestant database 11. In the embodiment illustrated in FIG. 1, a billing system 41 can be included within multi-modal interface 1 and can be connected to central processing unit 3 through connector 43. In another embodiment (not shown), billing system 41 can be integrated within the central processing unit. In another embodiment (not shown), billing system 41 can be located within FSL provider 9, and a connector can connect multi-modal interface 1 with the billing system.

Billing system 41 can be used to implement several different billing options. Typically, obtaining billing data through telephony-based devices in a secure manner is often problematic. In one embodiment, multi-modal interface 1 can be used to obtain such data from contestants that use digital devices which support encryption through the appropriate communication link. For contestants using telephony-based devices lacking this support, billing data may be gathered by having contestants talk directly to an operator. This type of communication may be orchestrated through central processing unit 3. In another embodiment, a contestant can provide a billing address and the billing can be carried out using traditional methods. In another embodiment, the billing system may be integrated with the telephony provider, through the use of 1-800, 1-900 numbers or VoIP systems. Other billing systems that may be used with the interface include, but are not limited to, the use of prepaid phone cards, bill-to-phone schemes and direct use of credit card information. Billing system 41 can be configured in such a way as to support both a one-time sign-up fee, as well as transaction-based fee. For example, a transaction fee may be charged for transactions such as making trades, accessing statistics from the FSL, and the like.

Once a contestant has completed registration through multi-modal interface 1, virtual team selection can begin. To facilitate the selection of players of interest, a contestant may be given access to various information deemed relevant to the FSL. This information may have been gathered by the FSL itself, or it may have been obtained from a third party, such as the governing body of a sports league or statistics provider 33. In either case, this information can be stored in players of interest database 7, as described above.

In one embodiment of the present invention, queries to players of interest database 7 can be done exclusively by voice. The integration of an IVR system as described above can allow for generic queries, such as “Who had the most points last season?”. In another embodiment, the types of queries that can be made through multi-modal interface 1 can be more structured. For example, which is not meant to be limiting, a contestant can be provided with menus of choices for information, and the contestant can choose to hear these predetermined categories. As discussed above, due to the interface's ability to recognize the characteristics of a contestant's specific telephony-based device, the information can be sent in conventional manner such as via messaging or through a browsing engine.

To simplify virtual team selection, in one embodiment, a contestant may select a player of interest using only the player's name through multi-modal interface 1. Selection of players using voice-only commands eliminates the need for printed publications, where, typically, lists of available players of interest are published with an identification code, which must be used for virtual team selection. Voice-only queries and commands can thus greatly simplify virtual team selection and management, as well as make the entire process more accessible and user-friendly. In another embodiment, multi-modal interface 1 can index players of interest by their teams, either through the team name or through the city for which their team plays. This can greatly simplify selection, mostly in FSLs where selection of players of interest from different sports teams of interest occurs. Once a contestant has selected a virtual team of players, each player within the virtual team can be found through voice queries by their name, their number, their primary statistics, and the like. Such voice queries can be performed using a number of different ways, using various systems, which can include, but are not limited to, an IVR system, as described above. The indexing may be performed by the multi-modal interface, or may be provided by the FSL provider. A contestant's virtual team selection can be stored within team roster database 5.

Depending upon the overall organization of the FSL, a contestant may update information within the team roster database 5. These updates can be considered as transactions, which may be billed depending on the type. In another embodiment, there may be a number of free transactions, followed by billed transactions. The overall system of transaction billing may be entirely determined by the FSL provider, and the multi-modal interface may carry out billing according to the provider's system.

Typically in a FSL, there are two major types of transactions: (1) updates to currently selected games, and (2) selections for new games. These two types of transactions can be quite different, as one may involve a contestant fine-tuning his/her virtual team selection over a long period of time such as an entire season, whereas the other type may involve making changes for a short-term event such as a daily match. Transactions may be driven by changes in the attributes of a player of interest (for example, as a result of injury), or may be driven by events or the anticipation of pending events, such as the elimination of a team during playoffs.

As discussed above for virtual team selection, transactions may be performed using voice-only commands through the use of various systems, which can include, but are not limited to, an IVR system. For example, a contestant can connect with multi-modal interface 1 and request the following: “Trade New York number 14 for Toronto number 93”. Typically the system will verify the transaction by asking the contestant for confirmation. For example, the contestant can be asked: “You want to trade New York's Mike Catch for Toronto's Bill Yank?”. In another embodiment, transactions may be performed using a multi-modal interaction, whereby voice and another form of communication may be used. The overall configuration of the transaction and billing systems can allow for the accumulation of significant incremental revenue to a FSL as contestants attempt to position themselves within the FSL's point system.

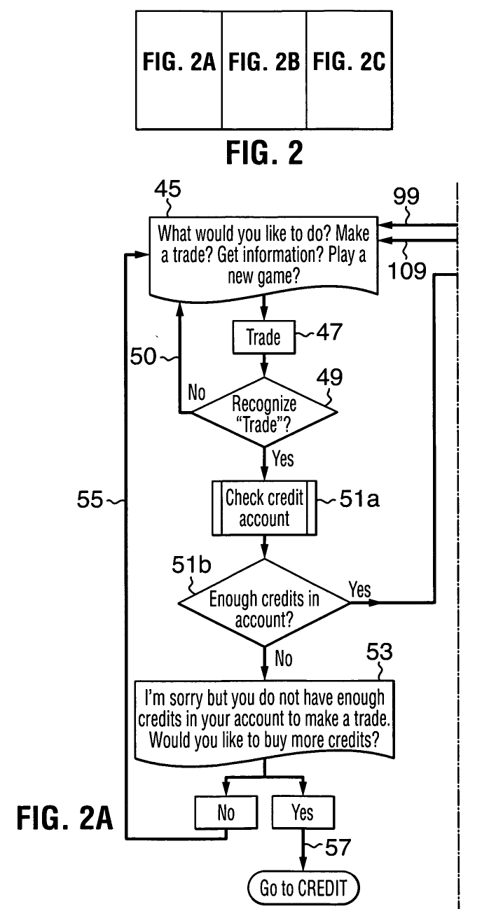

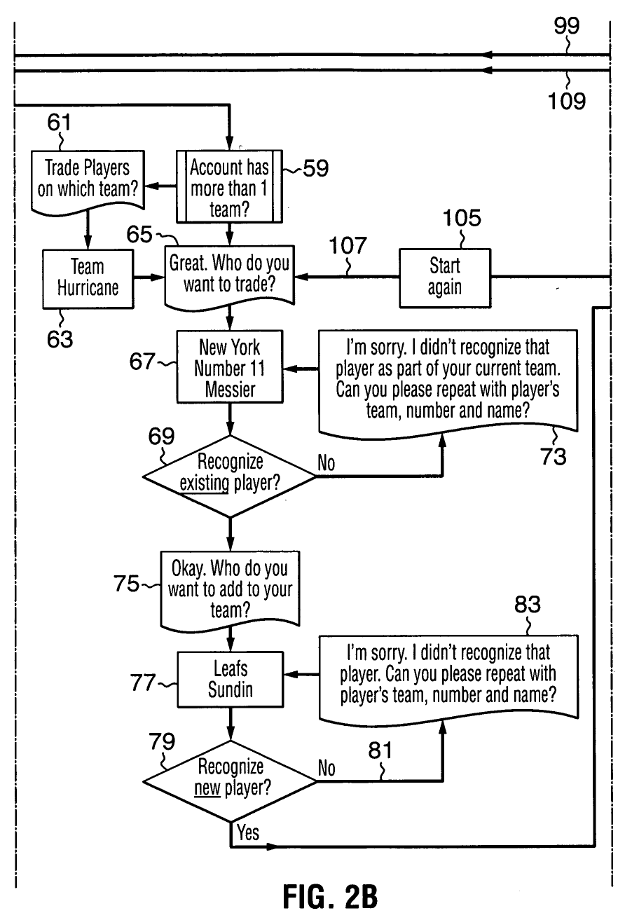

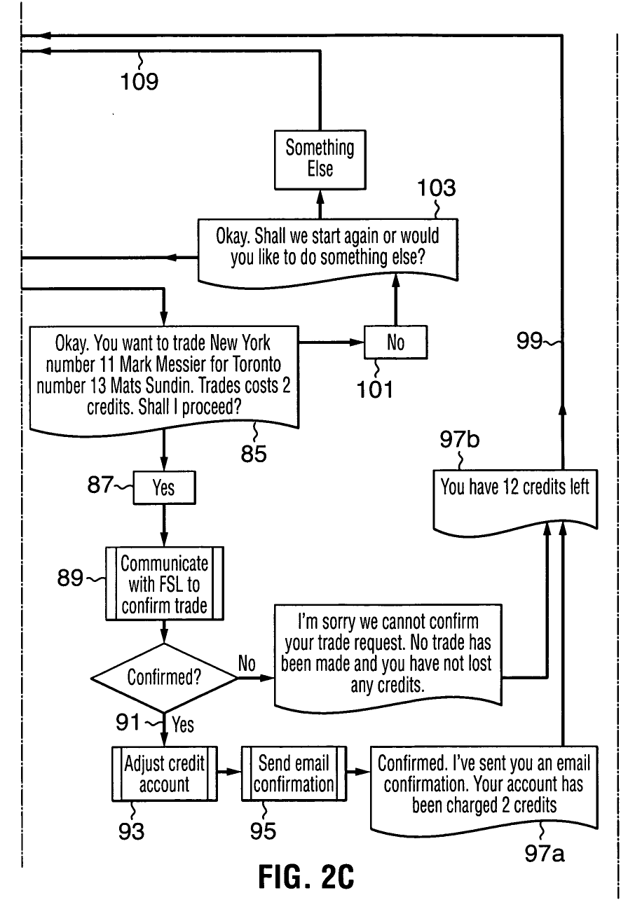

A flow diagram is provided in FIG. 2 showing an example of the trading of players of interest using voice-only commands by a contestant. Once the contestant has been authenticated, he/she is asked in step 45 which type of transaction he/she would like to perform. The transactions available for selection can include making a trade, obtaining information and/or playing a new game. In the example illustrated in FIG. 2, making a trade is selected in Step 47 and the contestant can state this selection using a voice-only command, which can be enabled through the use of an IVR system, as described above. If the command is not recognized by multi-modal interface 1 in step 49, the contestant may be asked to repeat 50 the selection.

If the command is recognized, steps 51a and 51b can involve verifying that the contestant has a sufficient monetary balance to perform the transaction. In this embodiment, the billing system used involves the prepayment of fees, which are considered “credit”. However, as described above, any other type of billing system can be used, and depending on the billing system chosen, step 51 can be omitted or modified to reflect the chosen payment method. If there is an insufficient balance, step 53 can ask the contestant whether he/she wishes to add credit to his/her balance. If the contestant replies “no”, the contestant can be returned 55 to step 45. If the contestant replies “yes”, the contestant can be led 57 to another menu where additional credit can be added to his/her balance.

In the event that a sufficient balance is present, the next step 59 can involve verifying whether the contestant has one or more virtual teams active with the FSL. In the event that more than one virtual team is active, step 61 can involve asking the contestant to select the virtual team in which a trade is desired. Once the virtual team has been selected, the next step 65 can involve asking the contestant to name the player of interest he/she would like to trade. Step 65 can be the step following step 59 if the contestant only has one active virtual team. Once the player of interest is selected 67 by voice, step 69 can involve the recognition of the contestant's voice command, which can also involve the use of an IVR system as described above. If the command is not recognized 71, the next step 73 can involve asking the contestant to repeat the name of the player of interest. If the voice command was recognized, the next step 75 can involve asking the contestant for the name of the player of interest he/she wishes to add to the virtual team. Once the player is selected 77 by voice, step 79 can involve recognizing the contestant's voice command using an IVR system, as described above. If the command is not recognized 81, the next step 83 can involve asking the contestant to repeat the name of the player of interest. If the command is recognized, the next step 85 can involve confirming with the contestant that a particular player of interest be traded for another particular player of interest. If the contestant confirms 87 that the information is correct, the trade can be communicated through multi-modal interface 1 to the FSL provider in the next step 89. Once the information has been confirmed 91 with the FSL provider, the next step 93 can involve adjusting the contestant's balance to reflect the cost of the trade transaction. The next step 95 can involve sending confirmation to the contestant through various communication modes, which can include, but are not limited to, an electronic message. The next steps 97a and 97b can involve stating to the contestant that confirmation has been sent and reporting the amount of credit remaining in the balance. The contestant can then be returned 99 to step 45 to make another selection. If the contestant states that the information in step 85 is incorrect 101, the next step 103 can involve asking the contestant whether he/she would like to return to step 45 to make another selection or whether he/she would like to make another trade. If the contestant decides to make another trade 105, he/she is returned 107 to step 65. Otherwise, the contestant is returned 109 to step 45.

In much the same manner as transactions can be made, in one embodiment, a contestant may use multi-modal interface 1 to perform queries using voice-only commands to obtain various information, which can include, but are not limited to, their position within the standings, how many points separate them from a specific position, how close they are to a prize, various statistics of players of interest, and the like. Such types of queries can often be followed by a transaction in which a trade may be made. Multi-modal interface 1 can facilitate these types of queries and transactions in such a way that these can be made in a single session. Again, as discussed above, the billing schemes surrounding these types of queries and transactions may be determined at the interface level, or by the FSL provider.

The contestant can either contact the FSL to obtain desired information, or, in one embodiment, instead of contacting multi-modal interface 1 to gain information or make transactions, a contestant may arrange to be notified of various information. Depending on the type of telephony-based device a contestant is using, such notifications can occur through a live phone call, a voice mail, or messaging. These types of notifications can be requested by the contestant during registration or at a later time. The contestant may choose and configure not only the type of information for which notification is requested, but also the preferred interface (i.e., voice, messaging, etc.) for each type of notification. These preferences can be stored in team roster database 5.

In one embodiment, notifications need not be done in real time. A contestant can specify a particular schedule for the receipt of notifications. For example, during the regular season for a major sport, a contestant may want to have notifications waiting on their telephony-based device each morning, outlining certain information from the previous day. For a sport like golf, a contestant may want to be notified of upcoming events so that they may appropriately configure their selections in the FSL.

In another embodiment, notifications can be personalized. For example, if a player of interest is injured, this information may only be sent to contestants who currently have this player as a member of their virtual teams. Thus, notification messages can be formatted both with content and format for individual contestants.

As noted above, contestants may decide not to be notified directly, but rather to phone into multi-modal interface 1 for information at a desired time. In this case, important information can be buffered between contestant queries so that whenever the contestants connect to the FSL provider, they receive all relevant information. As described above, this information can be provided through an IVR system, or through a multi-modal interaction.

For example, which is not meant to be limiting, the following personalized and customized notification can be sent by multi-modal interface 1 or accessed by a contestant in a FSL:

“Hi [contestant name]. This is Michele from the Fantasy Sports Pool. Last night your players did well combining for 7 points. Mat Sundin scored 1 goal and had 3 assists, Mark Messier had 2 assists and Steve Yzerman scored 1 goal. Your current point total is 257 and you are ranked first in your league and 119^{th} overall. If you'd like more information call me at 1-XYZ-ABC-DEFG. Goodbye.”

As described above, the form in which the notification is sent or accessed can be pre-determined by the contestant.

Due to the nature of the interactions between a contestant and a FSL through multi-modal interface 1, it is possible to introduce marketing and promotional activities. These types of marketing and promotional activities can be unavoidable, or can be permission-based. A contestant can specify during registration or at a later time whether promotional material can be presented in their interactions with the FSL. Several different types of marketing activities can be supported, and can include, but are not limited to, generic marketing activities, context sensitive activities, and personalized activities. Generic marketing can include, but is not limited to, global advertising, sponsorship, m-commerce, product marketing and e-coupons. For example, a message such as “Brought to you by . . . ” can accompany voice notifications. Transactions can be prefaced with audio segments, and queries can be prefaced by statements such as “carried out by”. Within multi-modal interactions, voice-based marketing instruments can be intermixed with more traditional text and graphics-based messages. Context-sensitive marketing can occur based upon the type of FSL being played, the position of the contestant within the league, current events, and the like. Personalized messages can also be scheduled based on a contestant's interests and activities, which can be recorded during registration. In one embodiment, multi-modal interface 1 can have the ability to “learn”, through algorithms such as neural networks and the like, the type of marketing information in which a contestant is most interested, and give the contestant's preferences priority in scheduling advertising or promotional items.

While the invention has been described in conjunction with the disclosed embodiment, it will be understood that the invention is not intended to be limited to these embodiments. On the contrary, the current protection is intended to cover alternatives, modifications and equivalents, which may be included within the spirit and scope of the invention. Various modifications will remain readily apparent to those skilled in the art.

1. A multi-modal interface for facilitating access to an interactive sports contest using a telephony-based device, comprising
(a) an interactive voice recognition system; and
(b) a central processing unit which provides access to a database of contestants and a database of players of interest, wherein a contestant in the interactive sports contest can register, select a virtual team of players and manage the team through the multi-modal interface.

2. The interface of claim 1, wherein the contestant can query the databases using voice-only commands.

3. The interface of claim 1, wherein the contestant can make transactions using voice-only commands.

4. The interface of claim 1, wherein the interactive voice recognition system comprises a voice recognition engine and a text-to-speech engine.

5. The interface of claim 1, wherein the interface further comprises a billing system.

6. The interface of claim 1, wherein the interface facilitates access to the interactive sports contest using a location-based system.

7. A method for facilitating access for contestants to an interactive sports contest, which method comprises the steps of:
(a) providing a multi-modal interface comprising an interactive voice response system to which the contestants can connect using telephony-based devices;
(b) using the interactive voice response system, recording voice-only commands from the contestants for registration, team selection and management transactions;
(c) storing recorded information in a database of registered contestants; and
(d) responding to the voice-only queries of contestants and sending requested information in a format optimized for the telephony-based devices of the contestants.

8. The method of claim 7, wherein the requested information is sent by voice.

9. The method of claim 7, wherein the requested information is sent by voice message.

10. The method of claim 7, wherein the requested information is sent by a web interface.

11. The method of claim 7, wherein the method further comprises charging a fee for each transaction and query made by the contestants.

12. A system for sending a notification of data or events to a contestant in an interactive sports contest through a telephony-based device, comprising:
(a) a database of contestants registered with the interactive sports contest;
(b) a database of data on professional sports players;
(c) an interactive voice recognition system; and
(d) a central processing unit.

13. The system of claim 12, wherein the contestant can configure which data and events will trigger sending the notification.

14. The system of claim 12, wherein the database of contestants contains instructions by the contestants on the type and frequency of the requested notification.

15. The system of claim 12, wherein the notification is sent daily.

16. The system of claim 12, wherein the notification is sent by voice.

17. The system of claim 12, wherein the notification is sent by voice message.

18. The system of claim 12, wherein the notification is sent by a messaging interface.

19. The system of claim 12, wherein the notification is sent through a web interface.

20. The system of claim 12, wherein the notification is sent in almost real time.
